(19) United States
(12) Patent Application Publication
(10) Pub. No.: US 2025/0045658 A1
(43) Pub. Date: Feb. 6, 2025

(54) SERVICE REQUEST ALLOCATION SYSTEM AND METHOD UNDER LACK OF AVAILABLE SERVICE PROVIDERS CONDITION

(71) Applicant: GRABTAXI HOLDINGS PTE. LTD., Singapore (SG)

(72) Inventors: Henokh Yernias FIBRIANTO, Singapore (SG); Zhi Kang WONG, Singapore (SG); Yibo JI, Singapore (SG); Jun Jie Larry LIN, Singapore (SG); Panos MAVROKONSTANTIS, Singapore (SG); Jiaxiang FU, Singapore (SG)

(21) Appl. No.: 18/718,107

(22) PCT Filed: Nov. 25, 2022
(86) PCT No.: PCT/SG2022/050860

§ 371 Date: Jun. 10, 2024

(30) Foreign Application Priority Data
Dec. 10, 2021 (SG) 10202113764V

(51) Int. Cl. G06Q 10/0631; G06Q 50/40

(52) U.S. Cl. CPC G06Q 10/063116; G06Q 10/06316; G06Q 50/40

(57) ABSTRACT

The present disclosure provides a system and a method for allocating one of a plurality of service requests to a service provider, each service request of the plurality of service requests requiring the service provider to move from one location to another to complete the each service request, the method comprising: detecting a first predicted severity level of a lack of available service providers for completing available service requests condition at a destination location indicated in a service request of the plurality of service request during an estimated arrival time window within which the service provider is estimated to move to the destination location from a pickup location to complete the service request; increasing a priority level of the service request based on the first predicted severity level; and allocating one service request associated with a highest priority level from the plurality of service requests to the service provider.

### TECHNICAL FIELD

The present invention relates generally to a system and a method for adaptively allocating a service request to a service provider, more particularly, under a lack of available service providers for completing available service requests condition at a specific location.

### BACKGROUND

A lack of available service providers condition, or called supply crunch situation where demand outstrips supply, the amount of orders that can be fulfilled is limited by the number of available drivers nearby. To alleviate this condition, a few strategies are devised to move the service providers, e.g., drivers for ride hailing service, towards the low supply areas or locations. For example, a heatmap product can provide information to service providers about the areas that are undersupplied, and dynamic incentives can provide service providers with monetary incentives to move towards the undersupplied areas to complete a service request (e.g., a booking for a ride hailing service) that starts in the undersupplied area. However, such strategies heavily rely on the service providers' willingness to move and/or to take on the incentives, and therefore is less effective and more costly for the service regulator who operates, regulates and facilitates the services.

There is thus a need to devise a novel method and system for adaptively allocating one of a plurality of service requests to a service provider in a lack of available service providers condition, which utilizes service request allocation for supply repositioning, and will (i) improve allocation during peak hours and improve satisfaction of a user (e.g., a service requester or a person who initiate a service request) of the service; (ii) improve productivity by more efficiently positioning the service providers in the areas (e.g., an undersupplied location) which they can serve and (iii) result in better market repositioning and lower operational cost for the service/server regulator to operate and regulate the services. Furthermore, other desirable features and characteristics will become apparent from the subsequent detailed description and the appended claims, taken in conjunction with the accompanying drawings and this background of the disclosure.

### SUMMARY

In a first aspect, the present disclosure provides a method for adaptively allocating one of a plurality of service requests to a service provider, each of the plurality of service requests requiring the service provider to move from one location to another to complete the each of the plurality of service requests, the method comprising: detecting a first predicted severity level of a lack of available service providers for completing available service requests condition at a destination location indicated in a service request of the plurality of service request during an estimated arrival time window within which the service provider is estimated to move to the destination location from a pickup location to complete the service request; detecting a second predicted severity level of the lack of available service providers for completing available service requests condition at a current location of the service provider during one of a current time window, a time window subsequent to the current time window and the estimated arrival time window; increasing a priority level of the service request based on the first predicted severity level and/or decreasing the priority level of the service request based on the second predicted severity level window; and allocating one service request associated with a highest priority level from the plurality of service requests to the service provider.

In a second aspect, the present disclosure provides a system for adaptively allocating one of a plurality of service requests to a service provider, each of the plurality of service requests requiring the service provider to move from one location to another to complete the each of the plurality of service requests, the system comprising: at least one processor; and at least one memory including computer program code; the at least one memory and the computer program code configured to, with at least one processor, cause the system at least to: detect a first predicted severity level of a lack of available service providers for completing available service requests condition at a destination location indicated in a service request of the plurality of service requests during an estimated arrival time window within which the service provider is estimated to move to the destination location from a pickup location to complete the service request; detect a second predicted severity level of the lack of available service providers for completing available service requests condition at a current location of the service provider during one of a current time window, a time window subsequent to the current time window and the estimated arrival time window; increase a priority level of the service request based on the first predicted severity level and/or decrease the priority level of the service request based on the second predicted severity level window; and allocate one service request associated with a highest priority level from the plurality of service requests to the service provider.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 shows a block diagram illustrating a service request allocation system according to various embodiments of the present disclosure.

FIG. 2 shows a block diagram illustrating various components of the allocation system 104 of FIG. 1 according to the embodiment.

FIG. 3 shows a flow chart illustrating a service request allocation method according to an embodiment of the present disclosure

FIG. 4 shows a map view illustrating a calculation of allocation of one of two service requests to a service provider according to an embodiment of the present disclosure.

FIG. 5 shows a flow chart illustrating a method for adaptively allocating one of a plurality of service requests to a service provider according to an embodiment of the present disclosure.

FIGS. 6 and 7 depict an exemplary server 600 for adaptively allocating one of a plurality of service requests to a service provider according to an embodiment of the present disclosure, upon which the service request allocation system in communication with the server described above can be practiced.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of this invention to present a service request allocation system and method under lack of available service providers condition.

### Terms Description

Service request-a service request refers to a demand for a service from an entity (herein referred to as requestor) through an software application programs hosted and managed by a service regulator, to move or deliver a person (e.g., the requestor himself/herself), his/her pet, his/her luggage, or goods such as food, grocery, merchandise, parcel, furniture or a combination thereof (herein referred to as object) from a first location (i.e., pickup location) to a second location (i.e., destination location). The service request will typically indicate the type of object, the pickup location where the object is collected and the destination location where the object is to be delivered to. Such request is allocated to a service provider to fulfil the request. According to the present disclosure, a service request corresponds to a demand for a service. The term “service request” and “booking” may be used interchangeably throughout the present disclosure.

Service provider-a service provider refers to a person who provides a service and completes a service request. This typically requires the service provider to uses a mode of transport to move from his/her current location (hereinafter may be referred to as “initial location”) to a pickup location indicated in the service request (unless he is already at the pickup location) and then from the pickup location to the destination location indicated in the service request to complete the service request. According to the present disclosure, a service provider corresponds to a supply for a service and will be allocated to a service request. Alternatively, the service provider may be allocated to multiple service requests and he/she then decides to accept one of the them to perform the service. The term “service provider” and “driver” may be used interchangeably throughout the present disclosure. In various embodiments below, such allocation of a booking to a driver is referred to as identification of a “booking-driver pair”, that is, to identify an available driver and match him/her with the booking. In one embodiment, upon identifying the “booking-driver pair”, information of the booking will be sent to the paired driver, and he/she will decide whether to accept the service request prior to performing the service.

Lack of available service providers for completing available service requests condition—a lack of available service providers for completing available service requests condition refers to a location-specific supply crunch situation where the demand for a service at a location outstrips its supply. This means that there is an imbalance between the amount of service request and available service providers. More particularly, the amount of service requests (e.g., food delivery order) that can be fulfilled is limited by the number of the available service providers (e.g., driver that delivers food order).

In various embodiments, supply/demand information with predicted number of available service providers and the predicted number of available service requests at various locations for future times and/or future time windows, e.g., the next 0-10, 10-20, 20-30, 30-40 minutes time windows from now, is received from a supply demand prediction system, and with the supply/demand information, locations, zones or regions which may suffer from supply crunch at certain future time(s) and/or time window(s) can be determined. Such supply/demand information will then be used to determine a predicted severity level of a supply crunch situation at a location at a future time window.

Predicted severity level-a predicted severity level of reflects the severity of a supply crunch situation at a location within a future time window that is predicted or determined using supply/demand information. A high predicted severity level corresponds to a more severe supply crunch situation or a greater imbalance between the supply and the demand at the location within the future time window. A predicted severity level can be derived by calculating the number of required service providers within each future time window, i.e., by taking the difference between the predicted number of available service providers (supply) and the predicted number of available service requests (demand) at the location within each future time window. Such predicted supply crunch situation at the location in future time window(s) will be utilized to adaptively adjust a priority level of a service request to be allocated to a service provider if the service request had that location specified as its destination location is able to move the service provider to ease the supply crunch at the location at that specific future time window(s).

In various embodiments, when a service request and an estimated arrival time window (future time window) within a service provider to arrive at the destination location are received, a predicted severity of a supply crunch condition of his/her current location and the destination location at the estimated arrival time window will be monitored and used for to adaptively adjust a priority level of the service request to be allocated to the service provider.

Estimated arrival time window—an estimated arrival time window refers to a future time window, e.g., the next 0-10, 10-20, 20-30, 30-40 minutes time windows from now, that a service provider will travel from his/her current location, to a pickup location specified in a service request and arrive at its destination location. Such estimated arrival time window is derived by a travel time prediction system from a record of travel durations required, for example by various service providers in the past, to move from locations to locations. In particular, the arrival time window may be estimated based on previous travel durations from the exact same current location to the pickup location and then from the pickup location to the destination location that are on record, or from a location close to the current/pickup/destination location when no or few previous travel records to/from that location are available. In one embodiment, the record of travel durations includes previous travel durations from locations to locations at various different periods of time of the day (e.g., peak and non-peak hours, weekdays and weekends), and the arrival time window is estimated based on the previous travel durations at the same or similar period of time of the day when the service request is received.

Priority level—a priority level indicates a priority of a service request being allocated to a service provider. The priority level of a service request varies from service providers to service providers depending on their respective locations and proximity to the pickup location of the service request. Each service provider will be allocated to a service request(s) with the highest priority level(s) among a plurality of service requests (e.g., all available service requests) at that time. In various embodiments, a priority level of a service request to be allocated to a service provider will be adaptively adjusted according to the predicted severity level of supply crunch condition of a destination location, pickup location and/or his/her current location. For example, the priority of the service request will be increased if the predicted severity level of the supply crunch situation at the destination location within some future time windows (e.g., estimated arrival time window) is high. This will allow the service request to be given higher priority to be allocated to the service provider. On the other hand, the priority of the service request will be decreased if the predicted severity level of the supply crunch situation at the service provider's current location within some future time windows (e.g., estimated arrival time window) is high. This will allow the service request to be given lower priority to be allocated to the service provider such that the service provider can stay around his/her current location to ease the predicted supply crunch situation his/her current location.

In one embodiment, an initial priority level of a service request to a service provider can be calculated based on a travel distance and/or a travel duration for the service provider to move from his/her current location to the pickup location specified in the service request, and this means that the service request with the highest initial priority level will generally be that the service provider takes the minimum travel distance and/or duration to travel from his/her current location to the pickup location. Such initial priority level calculated based on the travel distance and/or travel duration for the service provider to move from his/her current location to the pickup location will then be adaptively adjusted according to the predicted severity level of supply crunch condition of a destination location, pickup location and/or his/her current location.

It is noted that the term “priority level” may be associated with “assignment cost” or “allocation cost” which relates to a cost for the service regulator to operate a service and allocate a booking to a driver (e.g., due to distance, time, a cost of lost opportunity of an unmet service request or a gain of increased goodwill for fulfilling a service request). In generally, a priority level is inversely proportional to an assignment cost. More specifically, a booking-driver pair associated with a high (initial) priority level corresponds to a low (initial) assignment cost to assign the booking to the driver while a booking-driver pair associated with a low (initial) priority level corresponds to a high (initial) assignment cost to assign the booking to the driver. Similarly, where assignment cost is calculated to illustrate a priority level of a booking-driver pair, a subtraction in assignment cost corresponds to an increase in priority level while an addition in assignment cost corresponds to a decrease in priority level, and a booking which has a lowest assignment cost to a driver will be identified and allocated.

Service type-a service type categorizes a kind of service requests which, based on their properties or limitations of the service request and/or the object (e.g., fragility, temperature, pressure, volume, number of object, number of locations, distance, fixed dispatch/arrival time), requires different equipment, arrangements and/or setups from the service provider (e.g., type, size, function and speed of the vehicle, location of the service provider), the service regulator (e.g., service provider and request pairing criteria and algorithm) or at the source of the object before the delivery (e.g., way of dispatching and packaging) to fulfil. In other words, service requests which have exhibits similar properties and can be fulfilled by similar equipment, arrangements and/or setup from the service provider and the source of the object will be categorized under a same service type. Examples of a service type includes food delivery, parcel delivery, same-day grocery delivery, delivery using chilled/refrigerated truck or lorry delivery and ride haling or sharing for 2-person using a car, 7-person using a van or 26-person using a bus, pet-friendly transport, luxury car transport, cross-country transport, etc.

Constraint-a constraint may be referred to a limitation of a service provider to be allocated a service request to fulfil a service request. Examples of the constraint includes vehicle type, vehicle size, vehicle function, vehicle travel distance/speed, geographical location, and account balance, available time period of the service provider. In one embodiment, service providers will only be allocated to services of certain service type which they can fulfil based on their respective constraints.

### Exemplary Implementations

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which form public knowledge through their use. Such should not be interpreted as a representation by the present inventor(s) or the patent applicant that such devices in any way form part of the common general knowledge in the art.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

In the following paragraphs, various embodiments of the present disclosure which relates to a system and a method for adaptively allocating one of a plurality of service requests to a service provider are described.

A server or client (not shown) may host software application programs which provides an interface for its user to interact and an access to a service. Such server is associated with an entity (e.g. a company or organization) acting as a moderator, operator or regulator of the service.

The server, in turn, is in communication with hosts via respective connections. Such connections may be a network (e.g., the Internet). The hosts are servers. The term “host” is used herein to differentiate between the hosts and the server. The hosts are collectively referred to herein as the hosts, while the host refers to one of the hosts. The hosts may be combined with the server.

The host is a server associated with a user (e.g., a person, company or organization) which manages (e.g. establishes, administers) and stores information relating to user particulars, registry, account, account balance, service history, transaction history and other service/transaction operations. Such information may be stored in a database in communication with the host, the server or both. The host may be a computing device such as a desktop computer, an interactive voice response (IVR) system, a smartphone, a laptop computer, a personal digital assistant computer (PDA), a mobile computer, a tablet computer, and the like. In one example arrangement, the host is a computing device in a watch or similar wearable and is fitted with a wireless communications interface. In various embodiments, the host may be referred to as host device.

In the illustrative embodiment, each of the server and hosts provide an interface to enable communication with other connected server and hosts. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. For example, it is possible for each of the server and/or hosts to receive a service request (i.e., booking) to deliver an object from one location to another when a user presses a button on the GUI. It is also possible for each of the server and/or hosts to send a signal which include information of a service request (i.e., booking) to a host device associated with a nearby service provider. It is also possible for each of the server and/or hosts to receive a live location signal of a service provider when the service provider toggles a button on the GUI indicating that he/she is currently available to fulfil a service request.

Use of the term ‘server’ herein can mean a single computing device comprising a processor or a plurality of interconnected computing devices which operate together, each of which comprising a processor, to perform a particular function. That is, the server may be contained within a single hardware unit or be distributed among several or many different hardware units.

The server is also configured to manage the registration of users. A registered user has a remote access account which includes details of the user stored in a database in communication with the server, the host or both. The registration step is called on-boarding. A user may use either the host to perform on-boarding to the server and the service.

Details of the registration include, for example, name of the user, address of the user, contact number and email address of the user, and emergency contact. Once on-boarded, the user would have an account that stores all the details in the database.

It is not necessary to have an account at the server to access the functionalities of the server and the service. However, there are functions that are available to a registered user. For example, it may be necessary that only a registered user can be a service provider and fulfil any service request or pair his/her payment account with the user account.

The on-boarding process for a user is performed by the user through host. In one arrangement, the user downloads an application (which includes the API to interact with the server). In another arrangement, the user accesses a website which includes the API to interact with the server. The user is then able to interact with the server.

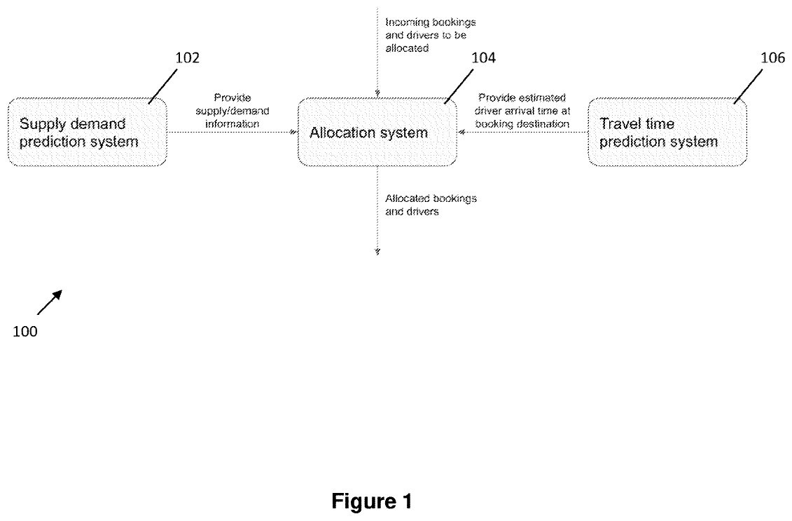

FIG. 1 shows a block diagram illustrating a system 100 for adaptively allocating a service request to a service provider according to various embodiments of the present disclosure. The system comprises an allocation system 104, a supply demand prediction system 102 and a travel time prediction system 106. The allocation system 104 is in communication of the supply demand prediction system 102 and the travel time prediction system 106 via connections. The connections may be wired, wireless (e.g., via NFC communication, Bluetooth, etc.) or over a network (e.g., the Internet). In an implementation, the system 100 comprises the server configured to receive data relating to all incoming bookings (e.g., user information, object, pickup location and destination location) and service providers (e.g., user information, location, vehicle) available at present. The server is in communication with the allocation system 104 and the supply demand prediction system 102 and the travel time prediction system 106 via connections. The connections may be wired, wireless (e.g., via NFC communication, Bluetooth, etc.) or over a network (e.g., the Internet). In another implementation, the allocation system 104 and the supply demand prediction system 102 and the travel time prediction system 106 may be implemented as part of the server, and the allocation system 104 and the supply demand prediction system 102 and the travel time prediction system 106 directly receive the data relating to incoming bookings and available service providers (e.g., drivers) from hosts.

The supply demand prediction system 102 is configured to provide a supply/demand signal that contains information about whether a location, zone or region will be under supplied at a certain time window in the future. The signal must be granular to at least a geohash-6 level, provide forecasts for a set of time windows that accounts for up to at least the 90th percentile of all bookings' estimated time of arrival (e.g. 0-10, 10-20, 20-30, 30-40 time windows), and updates at every regular interval (e.g., at least every two minutes). In one embodiment, The supply demand prediction system 102 is configured to a new supply/demand signal at every regular interval with the updated supply/demand information.

The signal should be split by product vertical or service type (e.g. transport, food delivery) and must factor in real-time allocation constraints, i.e. engineering and business filters on available drivers (e.g. fraud filters, insufficient account balance, inappropriate vehicle type, etc.).

The travel time prediction system 106 is configured to provide an estimated travel time from the driver's initial location to booking's destination location. The estimated travel time value received from the travel time prediction system 106 will be used by the allocation system 104 to determine the estimated time window a driver will arrive at the booking's destination location. Alternatively, such estimated arrival time window is determined by the travel time prediction system 106 and provided to the allocation system 104.

Upon receipt of the bookings and drivers information, the travel times or windows for completing each booking given different driver allocation, and the supply/demand signal, the allocation system is configured to determine whether a location will be under supplied by the time a driver arrives to complete the allocated booking, and apply a prioritization for the booking-driver pair, i.e., increase a priority level of the booking to be allocated to the driver, accordingly.

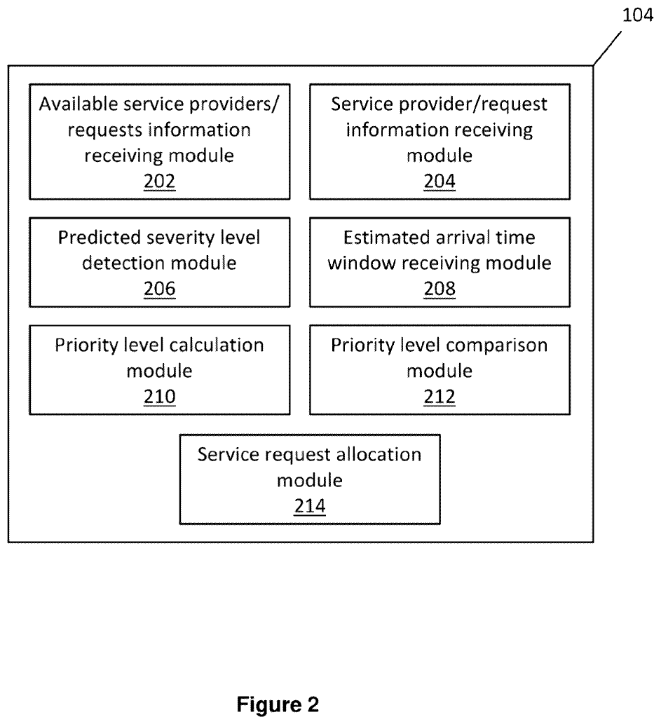

FIG. 2 shows a block diagram illustrating various components of the allocation system 104 of FIG. 1 according to the embodiment. In this embodiment, the allocation system 104 comprises an available service providers/requests information receiving module 202, a service provider/request information receiving module 204, a predicted severity level detection module 206, an estimated arrival time window receiving module 208, a priority level calculation module 210, a priority level comparison module 212 and a service request allocation module 214.

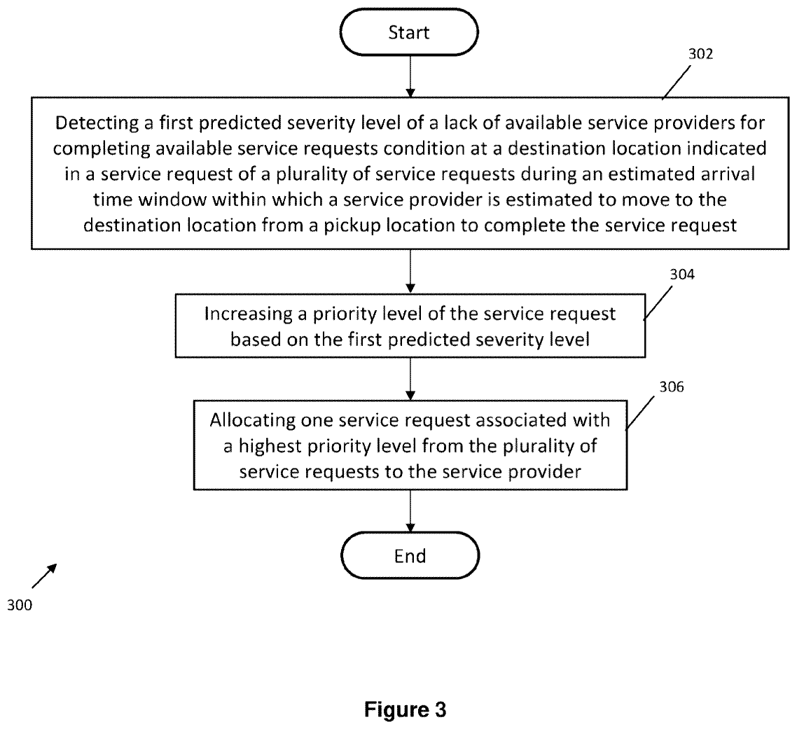

As shown in the exemplified method for adaptively allocating one of a plurality of service requests to a service provider in FIG. 3, the allocation system 104, when in operation, is configured to perform the following steps:
step 302: detecting a first predicted severity level of a lack of available service providers for completing available service requests condition at a destination location indicated in a service request of a plurality of service requests during an estimated arrival time window within which a service provider is estimated to move to the destination location from a pickup location to complete the service request;
step 304: increasing a priority level of the service request based on the first predicted severity level; and
step 306: allocating one service request associated with a highest priority level from the plurality of service requests to the service provider.

In step 302, the service provider/request information receiving module 204 receives information of incoming bookings and available drivers to be allocated from the server and/or hosts associated with the users. The available service providers/requests information receiving module 202 (or available drivers/bookings information module or supply/demand information module) receives a supply/demand information at various locations from the supply demand prediction system 102. Such supply/demand information may be updated and received at every regular time interval. For each incoming booking, the estimated arrival time window receiving module 208 receives, from travel time prediction system 106, an estimated arrival time window of every driver to arrive at the destination location of the booking. In one implementation, the available service providers/requests information receiving module 202, the service provider/request information receiving module 204 and the estimated arrival time window receiving module may be integrated into one receiving module. The predicted severity level prediction severity level detection module 206 then determines based on the (updated) supply/demand information and detects a predicted severity level of supply crunch condition at a destination location indicated in a booking during the estimated arrival time window of each driver.

In step 304, when a predicted severity level of supply crunch condition is detected at a destination location of a booking at an estimated arrival time window of a driver (take 30-40 minutes from now as an example), the priority level calculation module 210 increases a priority level of the booking to be allocated to a driver based on the predicted severity level of supply crunch condition detected at its destination location. In one embodiment, when a predicted severity level(s) of supply crunch condition is detected at the initial location of the driver during one of the current time window (e.g. within 10 minutes from now), a time window subsequent to the current time window (e.g., 10-20 minutes from now) and the estimated arrival time window (30-40 minutes from now), the priority level calculation module 210 decreases a priority level of the booking to be allocated to a driver based on the predicted severity level(s) of supply crunch condition detected at the driver's initial location. In various embodiments, for each incoming booking, the priority level calculation module 210 calculates an initial priority level of the booking to be allocated to every driver based on a travel distance and/or a travel duration required for the driver to arrive at the pickup location specified in the booking from his/her initial location, and the priority level calculation module 210 then adjust the priority level of such booking-driver pair according to the predicted severity level of supply crunch condition detected at its destination location and the initial location as described above.

Optionally, in step 304, prior to increase/decrease the priority level of a booking-driver pair, the priority level comparison module 212 determines a condition where that the difference between the predicted severity level of supply crunch condition detected at its destination location and the predicted severity level of supply crunch condition detected at the initial location is lower than a lower bound threshold, no adjustment to the priority level will be carried by the priority level calculation module 210. Alternatively or additionally, prior to increase/decrease the priority level of a booking-driver pair, the priority level comparison module 212 determines a condition where that the difference between the predicted severity level of supply crunch condition detected at its destination location and the predicted severity level of supply crunch condition detected at the initial location is higher than a lower bound threshold, a prioritization multiplier is applied to the adjustment so that the priority level will be adjusted to a greater degree. Alternative or additionally, prior to increase/decrease the priority level of a booking-driver pair, the priority level comparison module 212 determines a condition where the predicted severity level of supply crunch condition detected at the initial location is higher than the predicted severity level of supply crunch condition detected at its destination location, i.e., the supply crunch condition at the initial location is sever than the destination location, the booking will not be allocated to the driver.

In step 306, the service request allocation module 214 identifies one booking associated with a highest priority level from all incoming bookings and allocate it to the driver. The allocation system 104 or the service request allocation module 214 then sends a notification with information of the allocation and the booking information to the driver.

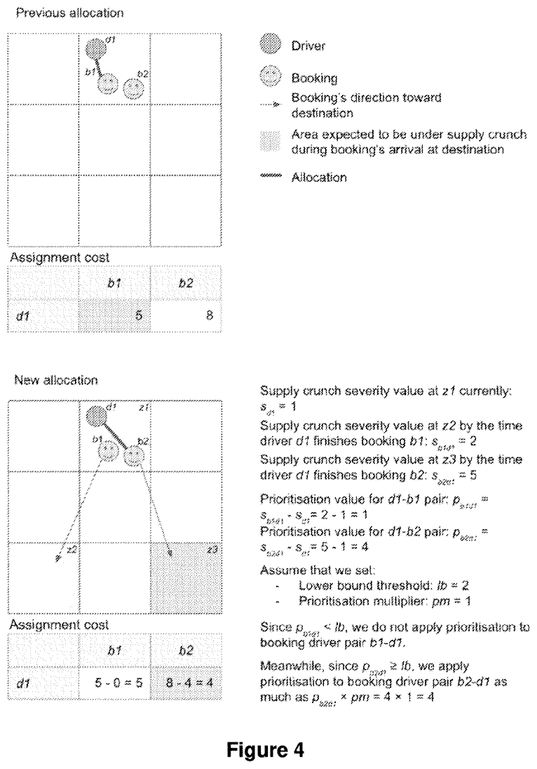

FIG. 4 shows a map view illustrating a calculation of allocation of one of two service requests to a service provider according to an embodiment of the present disclosure. In this embodiment, two bookings b1 and b2 with different pickup location in a zone z1 on the map are received. Respective initial assignment costs to assign the bookings to the driver d1 are calculated based on the travel distance/duration required for the driver to move from the driver's initial/current location to the respective pickup locations. In this case, an assignment cost of 5 is determined for booking-driver b1-d1 pair while an assignment cost of 8 is determined for booking-driver b2-d1 pair. Based on this initial assignment cost, booking-driver b1-d1 pair has a lower assignment cost (i.e., higher priority level) and therefore, the booking b1 is allocated to the driver d1.

In an implementation, where cost of assigning a booking to a driver is used, the prioritization is applied by subtracting an initial assignment cost

According to the present disclosure, prioritisation is applied by subtracting the cost of assigning a booking to a driver by a prioritisation value P which is computed as follows:

$$P = {S}_{destination} - {S}_{initial} \qquad equation ( 1 )$$

where S_{destination} refers to predicted supply crunch severity value at booking destination location by the time the driver arrives (i.e., during the estimated arrival time window) and predicted supply crunch severity value Sᵢₙᵢₜᵢₐₗ at driver's current/initial location in near future. Such prioritisation value P can be seen as the required adjustment to the assignment cost (or priority level where applicable) when taking account predicted supply crunch severity condition at booking destination location and driver's initial location.

Essentially, the S_{destination} value reduces the assignment cost (increase priority level) as it will bring the driver to the predicted under supply area if the booking is assigned to him, and the assignment cost adjustment also takes into account of Sᵢₙᵢₜᵢₐₗ. For example, if it is detected that the supply crunch at the driver's current location is predicted to be more severe (e.g., Sᵢₙᵢₜᵢₐₗ>S_{destination}) by the time the driver arrives the destination location, the assignment cost of a booking may increase such that the driver will assigned to the booking and direct the driver away from its current location. This will promote the driver to stay at his/her current location to ease the predicted supply crunch in near future.

Returning to FIG. 4, in this embodiment, the assignment costs of b1 and b2 are adjusted by the respective prioritization values which are calculated based on the predicted supply crunch severity values S_{b1d1}, S_{b2d1} at booking destination locations in zones z2 and z3 by the respective time windows the driver d1 is estimated to arrive at booking destinations as well as the predicted supply crunch severity value at the driver's initial location in zone z1 now using equation (1). The prioritization value for booking-driver b1-d1 pair p_{b1d1} is calculated to be 1 while the prioritization value for booking-driver b2-d1 pair p_{b2d1} is calculated to be 4.

Optionally, two hyperparameters for the prioritization logic can also be implemented, namely (i) a lower bound threshold lb which controls what severity level of the predicted lack of supply will trigger prioritisation, whose purpose is to adjust, based on the confidence of the supply/demand prediction signal, how aggressive the prioritisation would be; and (ii) a prioritisation multiplier pm, which controls how much prioritisation should be applied proportional to the predicted lack of supply. This means that the assignment cost (or priority level) will not be adjusted by the prioritisation value if the prioritization value is larger than the lower bound threshold lb. Additionally, the prioritisation value is further magnified or multiplied by the prioritisation multiplier pm if the prioritization value is larger than the lower bound threshold lb.

In this case, the lower bound threshold lb is 2 and the c multiplier pm is 1. As the prioritization value for booking-driver b1-d1 pair p_{b1d1} does not exceed the lower bound threshold, the assignment cost of the booking driver b1-d1 pair will not be adjusted and remains as 5. Meanwhile, as the prioritization value for booking-driver b2-d1 pair p_{b2d1} exceeds the lower bound threshold lb, the prioritization value is magnified by prioritisation multiplier pm to 4. As a result of the subtracting the prioritisation value from the initial assignment cost, the assignment cost of booking driver b2-d1 pair now becomes 4, which is than that of booking driver b1-d1 pair, therefore, the booking b2 is allocated to the driver d1.

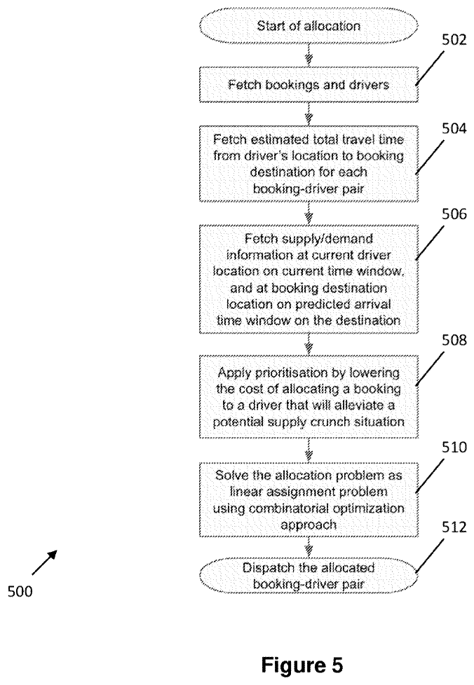

FIG. 5 shows a flow chart 500 illustrating a method for adaptively allocating one of a plurality of service requests to a service provider according to an embodiment of the present disclosure. In step 502, a step of fetching bookings and drivers is carried out. In step 504, a step of fetching estimated total travel time from driver's location to booking destination for each booking-driver pair is carried out. In step 506, a step of fetching supply/demand information at current driver location on current time window and at booking destination location on predicted arrival time window on the destination is carried out. In step 508, a step of applying prioritisation by lowering the cost of allocating a booking to a driver that will alleviate a potential supply crunch situation is carried out. In step 510, a step of solving the allocation problem as a linear assignment problem using a combinatorial optimization approach is carried out, for example by ranking the bookings according to their adjusted assignment costs or by applying a Hungarian algorithm to the adjusted assignment costs and identifying one or more booking-driver pairs with a lowest assignment cost is carried out. In step 512, a step of dispatching the allocated booking-driver pair.

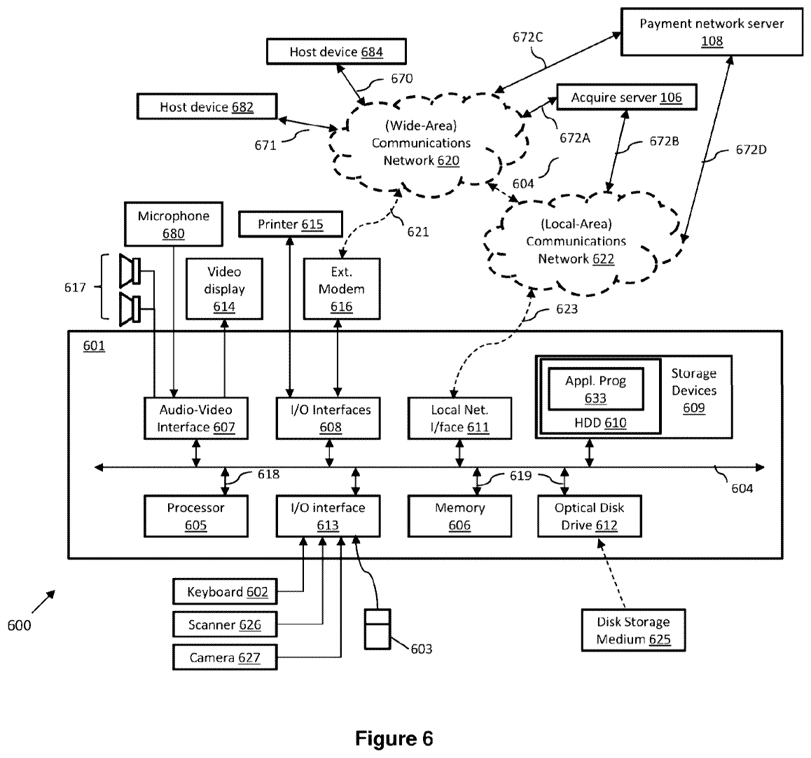

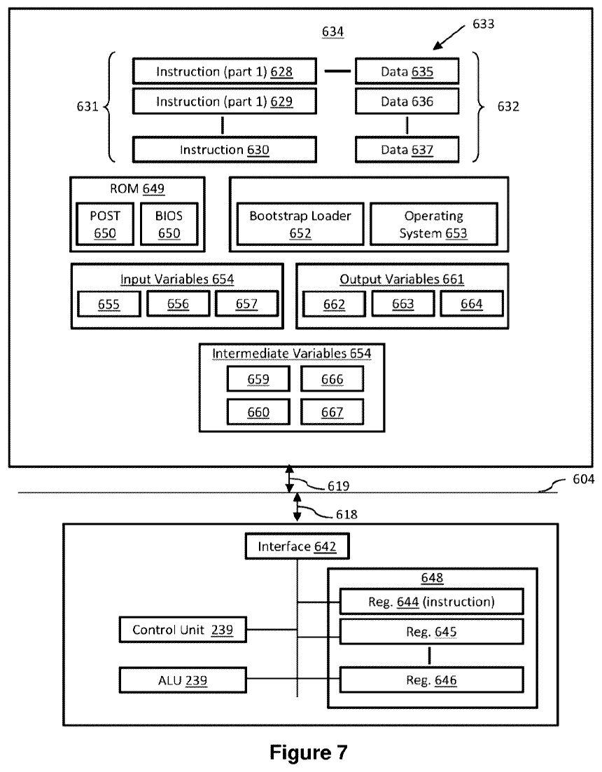

FIGS. 6 and 7 depict an exemplary server 600 for adaptively allocating one of a plurality of service requests to a service provider according to an embodiment of the present disclosure, upon which the service request allocation system in communication with the server described above can be practiced.

As seen in FIG. 6, the server 600 includes: a computer module 601; input devices such as a keyboard 602, a mouse pointer device 603, a scanner 626, a camera 627, and a microphone 680; and output devices including a printer 615, a display device 614 and loudspeakers 617. An external Modulator-Demodulator (Modem) transceiver device 616 may be used by the computer module 601 for communicating to and from a communications network 620 via a connection 621. The communications network 620 may be a wide-area network (WAN), such as the Internet, a cellular telecommunications network, or a private WAN. Where the connection 621 is a telephone line, the modem 616 may be a traditional “dial-up” modem. Alternatively, where the connection 621 is a high capacity (e.g., cable) connection, the modem 216 may be a broadband modem. A wireless modem may also be used for wireless connection to the communications network 660.

The input and output devices may be used by an operator who is interacting with the server 600. For example, the printer 615 may be used to print reports relating to the status of the server.

The server 600 uses the communications network 620 to communicate with the host devices 682, 684 to receive commands and data. The server 600 also uses the communications network 620 to communicate with the host devices 682, 684 to send notification messages or transaction data.

The computer module 601 typically includes at least one processor unit 605, and at least one memory unit 606. For example, the memory unit 606 may have semiconductor random access memory (RAM) and semiconductor read only memory (ROM). The computer module 601 also includes a number of input/output (I/O) interfaces including: an audio-video interface 607 that couples to the video display 614, loudspeakers 617 and microphone 680; an I/O interface 613 that couples to the keyboard 602, mouse 603, scanner 626, camera 627 and optionally a joystick or other human interface device (not illustrated); and an interface 608 for the external modem 616 and printer 615. In some implementations, the modem 616 may be incorporated within the computer module 601, for example within the interface 608. The computer module 601 also has a local network interface 611, which permits coupling of the computer system via a connection 223 to a local-area communications network 622, known as a Local Area Network (LAN). As illustrated in FIG. 6, the local communications network 622 may also couple to the wide network 620 via a connection 624, which would typically include a so-called “firewall” device or device of similar functionality. The local network interface 611 may comprise an Ethernet circuit card, a Bluetooth® wireless arrangement or an IEEE 802.11 wireless arrangement; however, numerous other types of interfaces may be practiced for the interface 611.

The I/O interfaces 608 and 613 may afford either or both of serial and parallel connectivity, the former typically being implemented according to the Universal Serial Bus (USB) standards and having corresponding USB connectors (not illustrated). Storage devices 609 are provided and typically include a hard disk drive (HDD) 610. Other storage devices such as a floppy disk drive and a magnetic tape drive (not illustrated) may also be used. An optical disk drive 612 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the server 600.

The components 605 to 613 of the computer module 601 typically communicate via an interconnected bus 604 and in a manner that results in a conventional mode of operation of a computer system known to those in the relevant art. For example, the processor 605 is coupled to the system bus 604 using a connection 618. Likewise, the memory 606 and optical disk drive 612 are coupled to the system bus 604 by connections 619. Examples of computers on which the described arrangements can be practised include IBM-PC's and compatibles, Sun Sparcstations, Apple Mac™ or like computer systems.

The methods of operating the server 600, as shown in the processes of FIGS. 2-4 to be described, may be implemented as one or more software application programs 633 executable within the server 600. In particular, the steps of the methods shown in FIGS. 2-4 are effected by instructions 231 (see FIG. 7) in the software (i.e., computer program codes) 633 that are carried out within the server 600. The software instructions 631 may be formed as one or more code modules, each for performing one or more particular tasks. The software may also be divided into two separate parts, in which a first part and the corresponding code modules performs the operation of the server 600 and a second part and the corresponding code modules manages the API and corresponding user interfaces in the host devices 682, 684, and on the display 614. In other words, the second part of the software manages the interaction between (a) the first part and (b) any one of the host devices 682, 684, and the operator of the server 600.

The software may be stored in a computer readable medium, including the storage devices described below, for example. The software is loaded into the server 600 from the computer readable medium, and then executed by the computer system. A computer readable medium having such software or computer program recorded on the computer readable medium is a computer program product. The use of the computer program product in the server 600 preferably effects an advantageous apparatus for adaptively allocating one of a plurality of service request to a service provider, functioning as a service request allocation system under a lack of available service providers condition.

The software (i.e., computer program codes) 633 is typically stored in the HDD 610 or the memory 606. The software 633 is loaded into the computer system from a computer readable medium (e.g., the memory 606), and executed by the processor 605. Thus, for example, the software 633 may be stored on an optically readable disk storage medium (e.g., CD-ROM) 625 that is read by the optical disk drive 612. A computer readable medium having such software or computer program recorded on it is a computer program product. The use of the computer program product in the server 600 preferably effects an apparatus for adaptively allocating one of a plurality of service request to a service provider, functioning as a service request allocation system under a lack of available service providers condition.

In some instances, the application programs 633 may be supplied to the user encoded on one or more CD-ROMs 625 and read via the corresponding drive 612, or alternatively may be read by the user from the networks 620 or 622. Still further, the software can also be loaded into the server 600 from other computer readable media. Computer readable storage media refers to any non-transitory tangible storage medium that provides recorded instructions and/or data to the server 600 for execution and/or processing by the processor 605. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 601. Examples of transitory or non-tangible computer readable transmission media that may also participate in the provision of software, application programs, instructions and/or data to the computer module 601 include radio or infra-red transmission channels as well as a network connection to another computer or networked device, and the Internet or Intranets including e-mail transmissions and information recorded on Websites and the like.

The second part of the application programs 633 and the corresponding code modules mentioned above may be executed to implement one or more API of the server 600 with associated graphical user interfaces (GUIs) to be rendered or otherwise represented upon the display 614 or the display of the host devices 682, 684. Through manipulation of typically the keyboard 602 and the mouse 603, an operator of the server 600 and the application may manipulate the interface in a functionally adaptable manner to provide controlling commands and/or input to the applications associated with the GUI(s). Similarly, on t the host devices 682, 684, a user of those devices 682, 684 manipulate the input devices (e.g., touch screen, keyboard, mouse, etc.) of those devices 682, 684 in a functionally adaptable manner to provide controlling commands and/or input to the applications associated with the GUI(s). Other forms of functionally adaptable user interfaces may also be implemented, such as an audio interface utilizing speech prompts output via the loudspeakers 617 and user voice commands input via the microphone 680. These other forms of functionally adaptable user interfaces may also be implemented on the host devices 682, 684.

FIG. 7 is a detailed schematic block diagram of the processor 605 and a “memory” 634. The memory 634 represents a logical aggregation of all the memory modules (including the HDD 609 and semiconductor memory 606) that can be accessed by the computer module 601 in FIG. 6.

When the computer module 601 is initially powered up, a power-on self-test (POST) program 650 executes. The POST program 650 is typically stored in a ROM 649 of the semiconductor memory 606 of FIG. 6. A hardware device such as the ROM 649 storing software is sometimes referred to as firmware. The POST program 650 examines hardware within the computer module 601 to ensure proper functioning and typically checks the processor 605, the memory 634 (609, 606), and a basic input-output systems software (BIOS) module 651, also typically stored in the ROM 649, for correct operation. Once the POST program 650 has run successfully, the BIOS 651 activates the hard disk drive 610 of FIG. 6. Activation of the hard disk drive 610 causes a bootstrap loader program 652 that is resident on the hard disk drive 610 to execute via the processor 605. This loads an operating system 653 into the RAM memory 606, upon which the operating system 653 commences operation. The operating system 653 is a system level application, executable by the processor 605, to fulfil various high level functions, including processor management, memory management, device management, storage management, software application interface, and generic user interface.

The operating system 653 manages the memory 634 (609, 606) to ensure that each process or application running on the computer module 601 has sufficient memory in which to execute without colliding with memory allocated to another process. Furthermore, the different types of memory available in the server 600 of FIG. 6 must be used properly so that each process can run effectively. Accordingly, the aggregated memory 634 is not intended to illustrate how particular segments of memory are allocated (unless otherwise stated), but rather to provide a general view of the memory accessible by the server 600 and how such is used.

As shown in FIG. 7, the processor 605 includes a number of functional modules including a control unit 639, an arithmetic logic unit (ALU) 640, and a local or internal memory 648, sometimes called a cache memory. The cache memory 648 typically includes a number of storage registers 644-646 in a register section. One or more internal busses 641 functionally interconnect these functional modules. The processor 605 typically also has one or more interfaces 642 for communicating with external devices via the system bus 604, using a connection 618. The memory 634 is coupled to the bus 604 using a connection 619.

The application program 633 includes a sequence of instructions 631 that may include conditional branch and loop instructions. The program 633 may also include data 632 which is used in execution of the program 233. The instructions 631 and the data 632 are stored in memory locations 628, 629, 630 and 635, 636, 637, respectively. Depending upon the relative size of the instructions 631 and the memory locations 628-630, a particular instruction may be stored in a single memory location as depicted by the instruction shown in the memory location 630. Alternately, an instruction may be segmented into a number of parts each of which is stored in a separate memory location, as depicted by the instruction segments shown in the memory locations 628 and 629.

In general, the processor 605 is given a set of instructions which are executed therein. The processor 605 waits for a subsequent input, to which the processor 605 reacts to by executing another set of instructions. Each input may be provided from one or more of a number of sources, including data generated by one or more of the input devices 602, 603, data received from an external source across one of the networks 620, 602, data retrieved from one of the storage devices 606, 609 or data retrieved from a storage medium 625 inserted into the corresponding reader 612, all depicted in FIG. 6. The execution of a set of the instructions may in some cases result in output of data. Execution may also involve storing data or variables to the memory 634.

The disclosed association management and payment initiation arrangements use input variables 654, which are stored in the memory 634 in corresponding memory locations 655, 656, 657. The association management and service request or payment initiation arrangements produce output variables 661, which are stored in the memory 634 in corresponding memory locations 662, 663, 664. Intermediate variables 258 may be stored in memory locations 659, 660, 666 and 667.

Referring to the processor 605 of FIG. 7, the registers 644, 645, 646, the arithmetic logic unit (ALU) 640, and the control unit 639 work together to perform sequences of micro-operations needed to perform “fetch, decode, and execute” cycles for every instruction in the instruction set making up the program 633. Each fetch, decode, and execute cycle comprises: a fetch operation, which fetches or reads an instruction 631 from a memory location 628, 629, 630; a decode operation in which the control unit 639 determines which instruction has been fetched; and an execute operation in which the control unit 639 and/or the ALU 640 execute the instruction.

Thereafter, a further fetch, decode, and execute cycle for the next instruction may be executed. Similarly, a store cycle may be performed by which the control unit 639 stores or writes a value to a memory location 632.

Each step or sub-process in the processes of FIGS. 3 and 5 is associated with one or more segments of the program 633 and is performed by the register section 644, 645, 647, the ALU 640, and the control unit 639 in the processor 605 working together to perform the fetch, decode, and execute cycles for every instruction in the instruction set for the noted segments of the program 633.

It is to be understood that the structural context of the server is presented merely by way of example. Therefore, in some arrangements, one or more features of the server may be omitted. Also, in some arrangements, one or more features of the server may be combined together. Additionally, in some arrangements, one or more features of the server may be split into one or more component parts.

The foregoing describes only some embodiments of the present disclosure, and modifications and/or changes can be made thereto without departing from the scope and spirit of the invention, the embodiments being illustrative and not restrictive.

1. A method for adaptively allocating one of a plurality of service requests to a service provider, each of the plurality of service requests requiring the service provider to move from one location to another to complete the each of the plurality of service requests, the method comprising:
detecting a first predicted severity level of a lack of available service providers for completing available service requests condition at a destination location indicated in a service request of the plurality of service request during an estimated arrival time window within which the service provider is estimated to move to the destination location from a pickup location to complete the service request;
detecting a second predicted severity level of the lack of available service providers for completing available service requests condition at a current location of the service provider during one of a current time window, a time window subsequent to the current time window and the estimated arrival time window;
increasing a priority level of the service request based on the first predicted severity level and/or decreasing the priority level of the service request based on the second predicted severity level; and
allocating one service request associated with a highest priority level from the plurality of service requests to the service provider.

2. The method according to claim 1, further comprising:
determining if a level difference between the first predicted severity level and the second predicted severity level is higher than a threshold level, wherein the priority level increment and/or decrement in relation to the service request is carried out in response to the determination of the level difference.

3. The method according to claim 2, further comprising:
in response to determining the level difference between the first predicted severity level and the second predicted severity level is higher than the threshold level, magnifying the priority level increment and/or decrement in relation to the service request by a preconfigured multiplier value.

4. The method according to claim 1, further comprising:
receiving the estimated arrival time window, wherein the estimated arrival time window is estimated based on previous travel durations required for the service provider and/or other service providers to move from the current location to the pickup location and then from the pickup location to the destination location.

5. The method according to claim 1, further comprises:
calculating a initial priority level of the service request of the plurality of service requests based a travel distance and/or a travel duration for the service provider to move from the current location to the pickup location, wherein the priority level increment and/or decrement in relation to the service request is carried out using the calculated initial priority level.

6. The method according to claim 1, further comprising:
at every regular time interval, detecting an updated first predicted severity level of the lack of available service providers for completing available service requests condition at the destination location during the estimated arrival time window and an updated second predicted severity level of the lack of available service providers for completing available service requests condition at the current location of the service provider, wherein the priority level increment and/or decrement in relation to the service request is carried out based on the updated first predicted severity level and/or the updated second predicted severity level respectively.

7. The method according to claim 6, wherein the received first predicted severity level and the received second predicted severity level, the plurality of service requests and the service provider relate to a same service type of a plurality of service types.

8. The method according to claim 1, further comprising:
receiving service provider information; and
evaluating a constraint of the service provider to complete the service request of the plurality of service requests or to be allocated to the service request associated with the highest priority level from the plurality of service requests based on the service provider information, the constraint relating to at least one of a vehicle type and an account balance; wherein the step of allocating the one service request associated with the highest priority level from the plurality of service requests to the service provider is carried out based on a result of the evaluation.

9. A system for adaptively allocating one of a plurality of service requests to a service provider, each of the plurality of service requests requiring the service provider to move from one location to another to complete the each of the plurality of service requests, the system comprising:
at least one processor; and
at least one memory including computer program code;
the at least one memory and the computer program code configured to, with at least one processor, cause the system at least to:
detect a first predicted severity level of a lack of available service providers for completing available service requests condition at a destination location indicated in a service request of the plurality of service requests during an estimated arrival time window within which the service provider is estimated to move to the destination location from a pickup location to complete the service request;
detect a second predicted severity level of the lack of available service providers for completing available service requests condition at a current location of the service provider during one of a current time window, a time window subsequent to the current time window and the estimated arrival time window; increase a priority level of the service request based on the first predicted severity level and/or decreasing the priority level of the service request based on the second predicted severity level; and
allocate one service request associated with a highest priority level from the plurality of service requests to the service provider.

10. The system according to claim 9, wherein the at least one memory and the computer program code is further configured with the at least one processor to:
determine if a level difference between the first predicted severity level and the second predicted severity level is higher than a threshold level, wherein the at least one memory and the computer program code is configured with the at least one processor to increase/decrease the priority level of the service request in response to the determination of the level difference.

11. The system according to claim 10, wherein the at least one memory and the computer program code is further configured with the at least one processor to:
magnify the priority level increment and/or decrement in relation to the service request by a pre-configured multiplier value in response to determining the level difference between the first predicted severity level and the second predicted severity level is higher than the threshold level.

12. The system according to claim 9, wherein the at least one memory and the computer program code is further configured with the at least one processor to:
receive the estimated arrival time window, wherein the estimated arrival time window is estimated based on previous travel durations required for the service provider and/or other service providers to move from the current location to the pickup location and then from the pickup location to the destination location.

13. The system according to claim 9, wherein the at least one memory and the computer program code is further configured with the at least one processor to:
calculate an initial priority level of the service request of the plurality of service requests based a travel distance and/or a travel duration for the service provider to move from the current location to the pickup location, wherein the at least one memory and the computer program code is configured with the at least one processor to increase/decrease the priority level of the service request using the calculated initial priority level.

14. The system according to claim 9, wherein the at least one memory and the computer program code is further configured with the at least one processor to:
at every regular time interval, detect an updated first predicted severity level of the lack of available service providers for completing available service requests condition at the destination location during the estimated arrival time window and an updated second predicted severity level of the lack of available service providers for completing available service requests condition at the current location of the service provider, wherein the at least one memory and the computer program code is configured with the at least one processor to increase/decrease the priority level of the service request based on the updated first predicted severity level and/or the updated second predicted severity level respectively.

15. The system according to claim 14, wherein the received first predicted severity level and the received second predicted severity level, the plurality of service requests and the service provider relate to a same service type of a plurality of service types.

16. The system according to claim 9, wherein the at least one memory and the computer program code is further configured with the at least one processor to:
receive service provide information; and
evaluate a constraint of the service provider to complete the service request of the plurality of service requests or to be allocated to the one service request associated with the highest priority level from the plurality of service requests based on the service provider information, the constraint relating to at least one of a vehicle type and an account balance; wherein the at least one memory and the computer program code is configured with the at least one processor to allocate the one service request associated with the highest priority level from the plurality of service requests to the service provider based on a result of the evaluation.
